(19) United States
(12) Patent Application Publication
(10) Pub. No.: US 2007/0092598 A1
(43) Pub. Date: Apr. 26, 2007

(54) INJECTION MOLD

(75) Inventor: CHIEN-SHENG TU, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,260

(22) Filed: Jul. 20, 2006

(30) Foreign Application Priority Data
Oct. 21, 2005 (CN) 200510100580.2

(51) Int. Cl. B29C 45/66

(52) U.S. Cl. 425/589; 425/542

(57) ABSTRACT

An injection mold includes a first mold plate (10), a second mold plate (60) mating with the first plate (10), a sliding block (20), a gear assembly (30), a first rack (40), and a second rack (50). The sliding block (20) is movably disposed on the first mold plate (10), and the first rack (40) is attached to the sliding block (20). The gear assembly (30) is configured for actuating the first rack (40). The second rack (50) is fixed on the second plate (60) for actuating the gear assembly (30).

### FIELD OF THE INVENTION

The present invention relates generally to injection molds and, more particularly, to an injection mold with a sliding block.

### DESCRIPTION OF RELATED ART

Injection molding is a conventionally known and commonly used manufacturing process. A typical injection mold has a sliding block for injection molding a complicated part such as the part with a lateral hole. The sliding block can be moved relative to a die disposed in the mold by an actuator member, thus a molded part with a desired shape can be formed. The actuator member for moving the sliding block is much important to the accuracy of the shape of the molded part.

Referring to FIG. 7, a conventional injection mold includes an upper mold die 81, a lower mold die 82 with a core 821, and two sliding blocks 83 movably disposed on two sides of the core 821 respectively. The upper mold die 81 has one pair of symmetrical slanting slots 811 defined for mounting a pair of guiding rods 812 therein. Each of the sliding blocks 83 has a slanting guiding hole 831. Each of the guiding rods 812 engages in a corresponding one of the slanting guiding hole 831. When the upper mold die 81 moves toward the lower mold die 82, the guiding rods 812 can actuate the sliding blocks 821 to move towards the core 821 until the upper mold die 81 engages with the lower mold die 82. However, the manufacturing process of the injection mold is complicated. Furthermore, abrasion of the guiding rods 812 and the slanting guiding hole 831 may cause the guiding rods 812 to become mis-aligned with or a poor fit to the slanting guiding hole 831, thus it may be difficult to reach a desired accuracy for the molded parts.

What is needed, therefore, is a simple injection mold, which can reach high accuracy for molded parts.

### SUMMARY OF THE INVENTION

In one embodiment thereof, an injection mold is provided. The injection mold includes a first mold plate, a second mold plate mating with the first plate, a sliding block, a first rack, a gear assembly, and a second rack. The sliding block is movably disposed on the first mold plate, and the first rack is attached to the sliding block. The gear assembly is configured for actuating the first rack. The second rack is fixed on the second plate for actuating the gear assembly.

Other advantages and novel features will become more apparent from the following detailed description of preferred embodiment when taken in conjunction with the accompanying drawings.

### BRIEF DESCRIPTION OF THE DRAWINGS

Many aspects of the injection mold can be better understood with reference to the following drawings. The components in the drawings are not necessarily drawn to scale, the emphasis instead being placed upon clearly illustrating the principles of the injection mold. Moreover, in the drawings, like reference numerals designate corresponding parts throughout the several views.

FIG. 1 is an exploded, perspective view of an embodiment of the injection mold;

FIG. 2 is a schematic view of the female mold plate of the injection mold in FIG. 1;

FIG. 3 is a schematic view of an injection mold, showing an open state;

FIG. 4 is a schematic view of the injection mold, showing a closed state;

FIG. 5 is a cross-sectional view along line VI-VI in FIG. 5, showing a closed state;

FIG. 6 is a cross-sectional view along line VI-VI in FIG. 5, showing an open state; and

FIG. 7 is a schematic view of a conventional injection mold with sliding blocks.

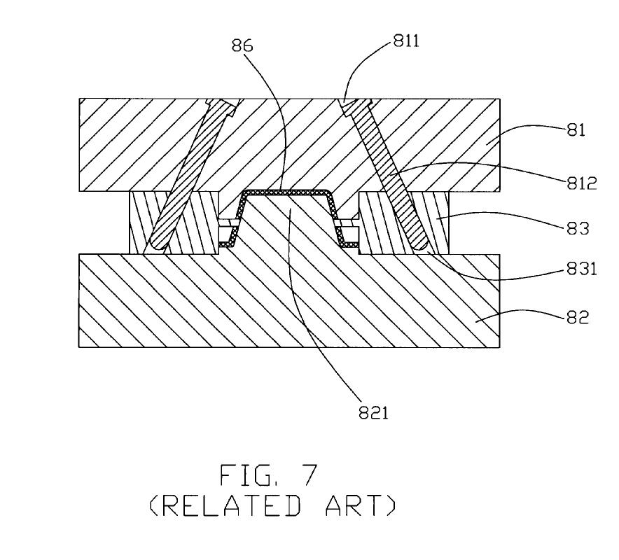

### DETAILED DESCRIPTION OF THE INVENTION

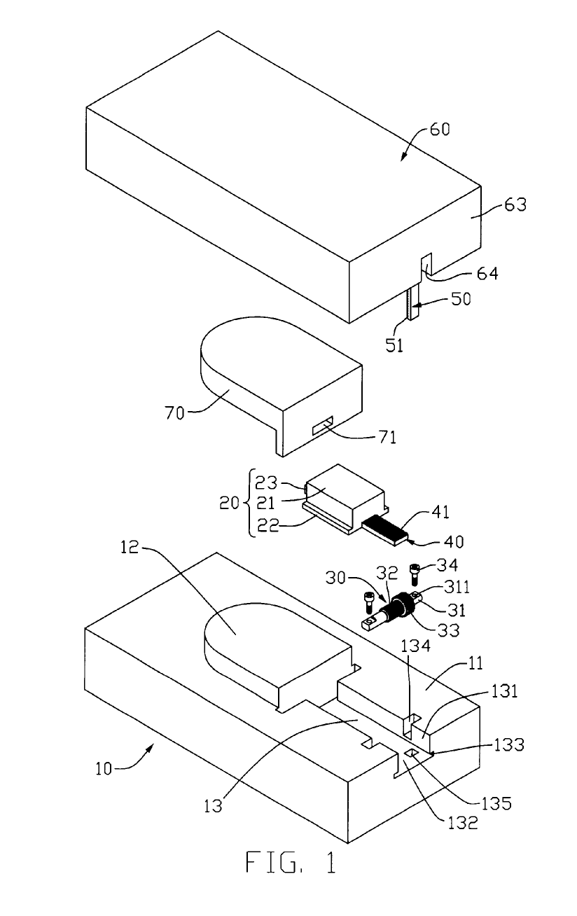

FIG. 1 shows an injection mold in accordance with a preferred embodiment. The injection mold includes a male mold plate 10, a sliding block 20, a gear assembly 30, a first rack 40, a second rack 50, and a female mold plate 60.

The male mold plate 10 has a top wall 11. The top wall 11 has a mold core 12 mounted thereon and a sliding groove 13 defined for accommodating the sliding block 20. The sliding groove 13 is formed at one side of the mold core 12. The sliding groove 13 is provided with one pair of opposing grooved sidewalls 131 and a downside wall 132. Each of the grooved sidewalls 131 has a side slot 133 along the direction of the sliding groove 13 and a rectangular opening 134 for positioning the gear assembly 30. A hole 135 is defined on the downside wall 132 for receiving one end of the second rack 50.

The sliding block 20 includes a main body 21, two arm stoppers 22, and a protrusion 23 for forming a part 70 of desired shape. The main body 21 can be cuboid. The arm stoppers 22 are symmetrically disposed on two opposing sides of the main body 21 respectively. The protrusion 23 can be a pin for forming a hole 71 on the part 70, and the protrusion 23 can be disposed on one end of the main body 21. The sliding block 20 can be movably accommodated into the sliding groove 13, and each of the arm stoppers 22 can engage in a corresponding side slot 133.

The gear assembly 30 includes a circular shaft 31, a first gear 32, a second gear 33 and two bolts 34. Each end of the circular shaft 31 has a screw hole 311 disposed thereon. Each of the bolts 34 can be threadedly engaged in the screw hole 311 respectively. The first gear 32 and the second gear 33 are straight-toothed gears, and are rotatably coiled around the shaft 31. The first gear 32 can integrally connect with the second gear 33. The first gear 32 and the second gear 33 rotate around the shaft 31. The gear ratio of the first gear 32 and the second gear 33 are determined by the mold stroke and the sliding stroke of the sliding block 20.

The first rack 40 and the second rack 50 have a strip-like shape. The first rack 40 has a first engaging side 41 with a plurality of teeth formed thereon, tooth flank 41, and the second rack 50 has a second engaging side 51 with a plurality of teeth formed thereon.

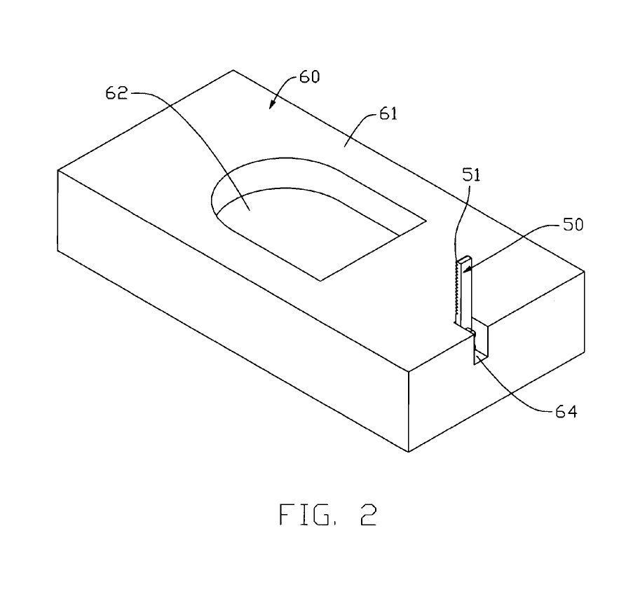

Referring to FIG. 2, the female mold plate 60, which mates with the male mold plate 10, is provided with a working wall 61 and a recessed portion 62 corresponding to the top wall 61 and the mold core 62 respectively. A receiving groove 64 is formed at one corner of the working wall 61 for fixing one end of the second rack 50.

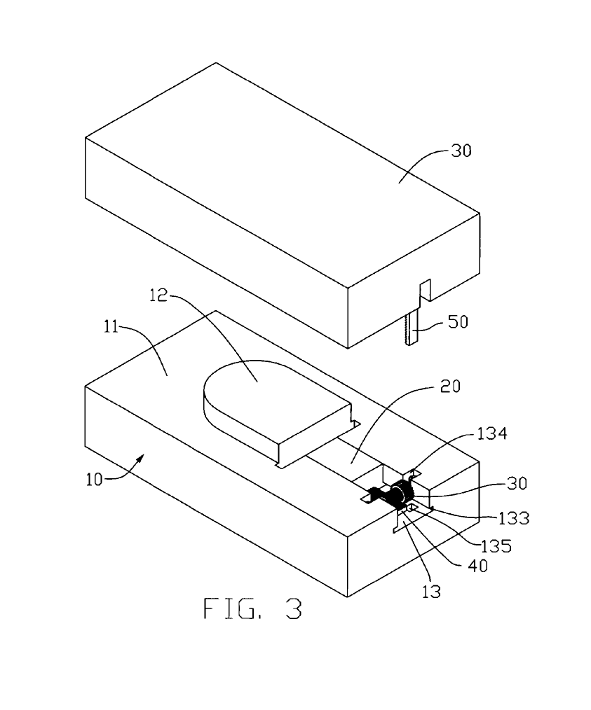

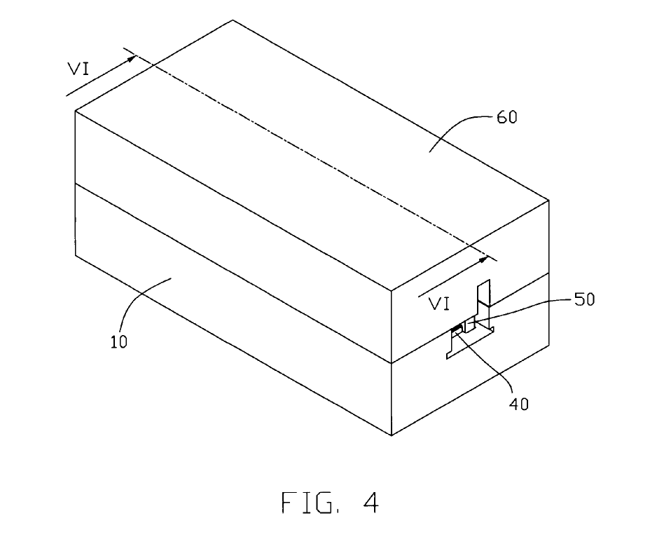

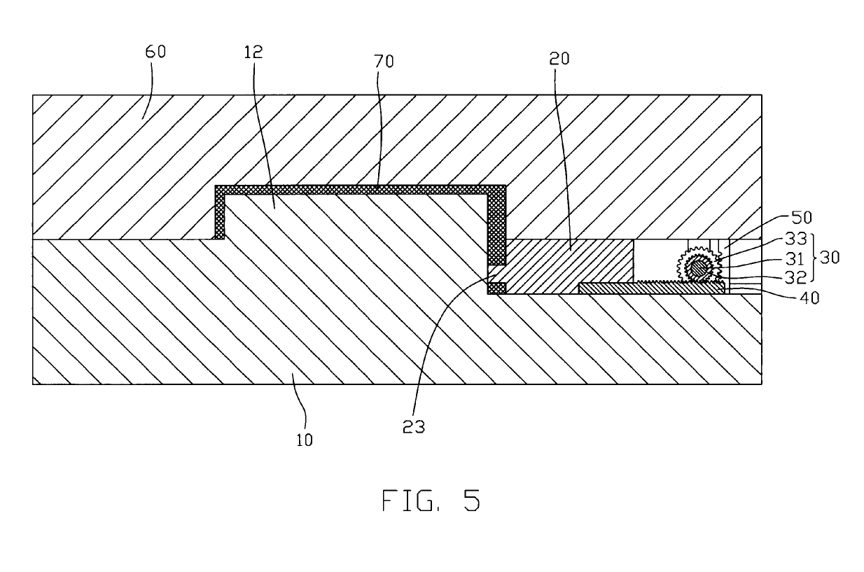

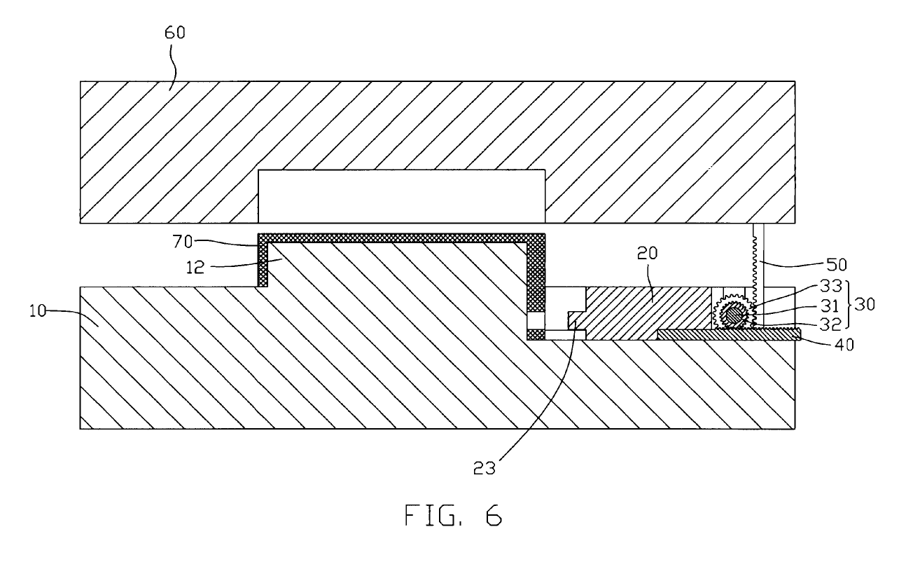

Referring to FIGS. 3-6 in assembly of the injection mold, the sliding block 20 is inserted into the sliding groove 13 with the protrusion 23 facing towards the mold core 12 thus allowing the sliding block 20 to slidably move along the sliding groove 13, with each of the arm stoppers 22 engaging in the corresponding side slot 133. One end of the first rack 40 attaches to the sliding block 20 opposing to the protrusion 23, with the other end of the first rack 40 extending out of the sliding block 20. The gear assembly 30 is secured in the rectangular opening 134, with each end of the shaft 31 being fixed in the corresponding rectangular opening 134 respectively via the bolts 34. The first gear 32 engages with the first tooth flank 41 of the first rack 40. One end of the second rack 50 is secured in the receiving groove 64 of the mold plate 60, and the other end of the second rack 50 is received in the hole 135, with the second tooth flank 51 engaging with the second gear 33. The second rack 50 can actuate the second gear 33, and the first gear 32 can actuate the first rack 40. The male mold plate 10, the sliding block 20, the gear assembly 30, the first rack 40, the second rack 50, and the female mold plate 60 are assembled together thereat.

When the injection mold is being closed, the female mold plate 60 moves toward the male mold plate 10 along a first axis that is parallel to the first engaging side 41 of the first rack 40. Simultaneously, the second rack 50 actuates the second gear 33 and the first gear 32 to rotate around the shaft 31. The first gear 32 may actuate the first rack 40 to push the sliding block 20 toward the mold core 12 along a second axis. The second axis is parallel to the second engaging side 51 of the second rack 50 and perpendicular to the first axis. A mold cavity can thereby be formed between the mold plate 10, the female mold plate 60, and the sliding block 20, with the protrusion 23 of the sliding block 20 extending into the molding cavity. Molten materials can be filled into the mold cavity to form the part 70.

When the injection mold is being opened, the female mold plate 60 moves away from the male mold plate 10 along the first axis, simultaneously the second rack 50 actuates the second gear 33 and the first gear 32 to rotate around the shaft 31. The first gear 32 may actuate first rack 40 to pull the sliding block 20 apart from the mold core 12 along the second axis. Thereby the molded part 70 can be taken away from the injection mold.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An injection mold, comprising:
a first mold plate;
a second mold plate mating with the first plate;
a sliding block movably disposed on the first mold plate;
a first rack attached to the sliding block;
a gear assembly configured for actuating the first rack so as to move the sliding block; and
a second rack fixed on the second mold plate and configured for actuating the gear assembly when the first mold plate and the second mold plate move relative to each other.

2. The injection mold as claimed in claim 1, wherein the gear assembly is mounted on the first mold plate.

3. The injection mold as claimed in claim 2, wherein the gear assembly includes a shaft, a first gear and a second gear, the first gear engages with the first rack, and the second gear engages with the second rack.

4. The injection mold as claimed in claim 3, wherein the first gear and the second gear are straight-toothed gears.

5. The injection mold as claimed in claim 4, wherein the first gear and the second gear are rotatably coiled around the shaft, and the first gear is integrally connected with the second gear.

6. The injection mold as claimed in claim 1, wherein the first mold plate has a top wall, the top wall has a mold core mounted thereon, and a sliding groove for accommodating the sliding block is defined on the top wall.

7. The injection mold as claimed in claim 6, wherein the sliding groove has one pair of opposing grooved sidewalls, and each of the grooved sidewalls has a rectangular opening for positioning the gear assembly.

8. The injection mold as claimed in claim 6, wherein each of the grooved sidewalls has a side slot disposed along the direction of the sliding groove, the sliding block has two arm stoppers are symmetrically disposed on two opposing sides of the sliding block respectively, the sliding block is received in the sliding groove, and each of the arm stoppers engages in a corresponding side slot respectively.

9. The injection mold as claimed in claim 6, wherein the second mold plate is provided with a working wall and a recessed portion corresponding to the top wall and the mold core respectively.

10. The injection mold as claimed in claim 6, wherein a receiving groove is formed at one corner of the working wall, and one end of the second rack is fixed on the receiving groove.

11. An injection mold, comprising:
a first mold member having a mold core disposed thereon;
a second mold member having a recessed portion positioned corresponding to the mold core, the second mold member coupled to the first mold member in a manner so as to allow their separation along a first axis;
a sliding block disposed between the first mold member and the second mold member and movable along a second axis distinct from the first axis, a mold cavity being defined between the first mold member, the second mold member and the sliding block;
a driving assembly including a first driving part fixed to the first mold member, a second driving part fixed to the sliding block, and an intermediate transmission part, wherein the transmission part engages with the first and second driving parts in a manner so as to transmit driving force from the first driving part to the second driving part to drive the sliding block to move along the second axis when the first and second mold members move relative to each other along the first axis.

12. The injection mold as claimed in claim 11, wherein the first axis is perpendicular to the second axis.

13. The injection mold as claimed in claim 11, wherein the sliding block comprises a protrusion extending into the molding cavity.

14. The injection mold as claimed in claim 11, wherein the first driving part has a first engaging side parallel to the first axis.

15. The injection mold as claimed in claim 14, wherein the second driving part has a second engaging side parallel to the second axis.

16. The injection mold as claimed in claim 11, wherein the transmission part is a gear assembly.

17. The injection mold as claimed in claim 16, wherein the first driving part and the second driving part are racks.

18. The injection mold as claimed in claim 17, wherein the gear assembly includes a first gear and a second gear, the first gear engages with the first driving part, and the second gear engages with the second first driving part.
